(19) United States
(12) Patent Application Publication
(10) Pub. No.: US 2026/0163027 A1
(43) Pub. Date: Jun. 11, 2026

(54) AIR SUPPLY MODULE FOR AN AIRCRAFT FUEL CELL SYSTEM

(71) Applicants: Airbus SAS, BLAGNAC (FR); Airbus Operations SAS, TOULOUSE (FR)

(72) Inventors: Franck ALVAREZ, TOULOUSE (FR); Benedikt BAMMER, TAUFKIRCHEN (DE)

(21) Appl. No.: 19/181,677

(22) Filed: Apr. 17, 2025

(30) Foreign Application Priority Data
Apr. 25, 2024 (FR) FR2404296

(51) Int. Cl. H01M 8/04089; B64D 27/355

(52) U.S. Cl. CPC H01M 8/04089; B64D 27/355; H01M 2250/20

(57) ABSTRACT

An air supply module for a system for producing electrical energy comprising a fuel cell, including a housing which has an inlet orifice and an outlet orifice and through which an air flow flows. The module includes, accommodated in the housing, a first filter and a first heat exchanger which are in direct fluidic communication with one another.

### CROSS-REFERENCES TO RELATED APPLICATIONS

This application claims the benefit of French Patent Application Number 2404296 filed on Apr. 25, 2024, the entire disclosures of which are incorporated herein by way of reference.

### FIELD OF THE INVENTION

The present invention relates to an air supply module for a system for producing electrical energy by means of a fuel cell using hydrogen, and to a system for producing electrical energy employing such a module. The invention also relates to a propulsion system supplied with electricity by such a system for producing energy, and to an aircraft comprising such a propulsion system.

### BACKGROUND OF THE INVENTION

In order to reduce the pollution caused by the use of jet fuel in the use of an aircraft, aircraft have been developed in which the motors are supplied with dihydrogen, H₂. More particularly, the dihydrogen is used to supply a fuel cell in order to generate an electric current which, in turn, runs the motor of the aircraft. In order to make the description easier to understand, a fuel cell is considered to be able to comprise a plurality of fuel cells. The generation of the electric current requires a chemical reaction of the dihydrogen with oxygen, O₂. Oxygen is present in the air and it is therefore necessary for the fuel cell to be supplied with air for this reaction to take place. To this end, a conventional system for producing electrical energy comprising a fuel cell has an air supply system. However, the flow of air provided by the air supply system needs to have a specific quality, temperature and moisture content in order not to damage the membrane of the fuel cell, in particular. These requirements are relatively difficult to ensure in an aircraft, however, since the environmental conditions of an airplane vary regularly (during a flight or while it is standing on the ground) over the course of a day. In particular, variations in altitude and temperature, the types of air pollution (such as particles of the sand, dust, etc. type) or the presence of certain gases (such as ozone, sulfur SO₂, H₂S, NOₓ, or NH₃) can deteriorate or damage the fuel cell.

Consequently, to ensure a long service life of the system as a whole, a number of components are required in the air supply system (for example filters, an intermediate cooler, a heat exchanger, etc.). These components are generally joined together by hoses and connections.

A drawback of this solution is that these components of the air supply system and the intermediate pipes and their connections exhibit a non-negligible volume and weight. Moreover, these components generally each have their own casing, making them relatively difficult to access and to replace during maintenance and/or servicing operations, in particular given that they can be disposed close to the fuel cell.

There is therefore a need to provide an air supply system which is less bulky and lighter and for which maintenance operations are easier.

### SUMMARY OF THE INVENTION

An object of the present invention is to provide an air supply module for a system for producing electrical energy comprising a fuel cell which is lightweight and compact and which is easy to incorporate into a system for producing electrical energy.

To this end, an air supply module for a system for producing electrical energy comprising a fuel cell is proposed, the module comprising a housing which has an inlet orifice and an outlet orifice and through which an air flow flows along a direction of flow between the inlet orifice and the outlet orifice.

According to the invention, the module comprises, accommodated in the housing, between the inlet orifice and the outlet orifice, a first filter having a first inlet and a first outlet for the air flow and a first heat exchanger having a second inlet and a second outlet for the air flow, the first heat exchanger being disposed downstream of the first filter with respect to the direction of flow. More specifically, the first outlet of the first filter and the second inlet of the first heat exchanger are in direct fluidic communication with one another.

The employment of such an air supply module makes it possible to reduce the volume (and therefore the space requirement) of the air supply and distribution circuit of the fuel cell, thereby making it easier to integrate the module into a system for producing electrical energy. Specifically, doing away with the use of connecting hoses between the first filter and the first heat exchanger, in particular, allows a relatively large saving of volume. In addition, such a module also allows a significant weight saving, this being relatively advantageous when the module needs to be installed onboard an aircraft.

Advantageously, the module also comprises, accommodated in the housing, between the inlet orifice and the outlet orifice:
a second heat exchanger having a third inlet and a third outlet for the air flow, the second heat exchanger being disposed downstream of the first heat exchanger, and
a second filter having a fourth inlet and a fourth outlet for the air flow, the second filter being disposed downstream of the second heat exchanger.

In particular, the second outlet of the first heat exchanger and the third inlet of the second heat exchanger are in direct fluidic communication with one another. The third outlet of the second heat exchanger and the fourth inlet of the second filter are in direct fluidic communication with one another.

According to one particular aspect, the module also comprises, accommodated in the housing, between the inlet orifice and the outlet orifice, a humidifier having a fifth inlet and a fifth outlet for the air flow, the humidifier being disposed downstream of the second filter. In particular, the fifth inlet of the humidifier and the fourth outlet of the second filter are in direct fluidic communication with one another. The fifth outlet of the humidifier and the outlet orifice of the module are in direct fluidic communication with one another.

According to one particular embodiment, the housing has internal walls that form a flow channel for the air flow between the inlet orifice and the outlet orifice. The internal walls place the first outlet of the first filter in direct fluidic communication with the second inlet of the first heat exchanger, and/or the second outlet of the first heat exchanger in direct fluidic communication with the third inlet of the second heat exchanger, and/or the third outlet of the second heat exchanger in direct fluidic communication with the fourth inlet of the second filter, and/or the fourth outlet of the second filter in direct fluidic communication with the fifth inlet of the humidifier.

According to one particular aspect of the invention, the module comprises a bypass circuit having a sixth inlet and a sixth outlet for a bypass flow, the bypass circuit being disposed between the inlet orifice and an additional outlet orifice of the housing. The inlet orifice and the sixth inlet are in direct fluidic communication with one another, and the sixth outlet and the additional outlet orifice of the housing are in direct fluidic communication with one another.

According to another particular aspect, the module comprises a recirculation circuit having a seventh inlet and a seventh outlet for a recirculation flow, the recirculation circuit being disposed between an additional air inlet orifice of the housing that is intended to be connected to a source of recirculation air and a first additional inlet of the first heat exchanger. The seventh inlet and the additional inlet orifice are in direct fluidic communication with one another, and the seventh outlet and the first additional inlet of the first heat exchanger are in direct fluidic communication with one another.

According to yet another particular aspect, the recirculation circuit also has a water separator having an eighth inlet and an eighth outlet for the recirculation flow, the water separator being disposed between the first heat exchanger and the humidifier. The additional inlet orifice and a second additional inlet of the humidifier are in direct fluidic communication with one another, and a second additional outlet of the humidifier and the eighth inlet of the water separator are in direct fluidic communication with one another such that the recirculation flow flows from the additional inlet orifice to the water separator, passing through the humidifier. The eighth outlet of the water separator and the first additional inlet of the first heat exchanger are in direct fluidic communication with one another.

According to another particular aspect, the recirculation circuit also has a bypass channel disposed between the additional inlet orifice of the housing and the eighth inlet of the water separator, the eighth inlet of the water separator and the additional inlet orifice being in direct fluidic communication with one another via the bypass channel such that the recirculation flow flows from the additional inlet orifice to the water separator, bypassing the humidifier.

According to a first embodiment, the bypass circuit and/or the recirculation circuit is/are mounted on the outside of the module.

According to a second embodiment, the bypass circuit and/or the recirculation circuit is/are formed by internal walls of the module.

According to one particular aspect of the invention, the first filter and/or the second filter is/are in the form of a cartridge that is removable from the housing.

According to another particular aspect, the first filter combines an ozone particle filter and a volatile organic compound converter, the first heat exchanger is of the air/air type, the second heat exchanger is of the liquid/air type, and the second filter is an adsorbent chemical filter.

The invention also relates to a system for producing electrical energy, comprising at least one fuel cell and at least one air supply module as described above, and to an electrical propulsion system which is supplied with electricity by at least one such system for producing electrical energy.

The invention also relates to an aircraft comprising at least one propulsion system as described above.

### BRIEF DESCRIPTION OF THE DRAWINGS

The features of the invention that are mentioned above, and others, will become more clearly apparent from reading the following description of an exemplary embodiment and the variants thereof, the description being given with reference to the appended drawings, in which:

FIG. 1 is a top view of an aircraft according to the invention;

FIG. 2 is a perspective view of an example of an air supply module according to the invention;

FIG. 3 is another perspective view of the module in FIG. 2;

FIG. 4a is a schematic view of an air supply module according to a first embodiment of the invention;

FIG. 4b illustrates the flows within the module in FIG. 4a;

FIG. 5a is a schematic view in cross section of an air supply module according to a second embodiment of the invention;

FIG. 5b illustrates the flows within the module in FIG. 5a;

FIG. 6a is a schematic view in cross section of an air supply module according to a variant of the second embodiment of the invention; and

FIG. 6b illustrates the flows within the module in FIG. 6a.

### DETAILED DESCRIPTION OF THE PREFERRED EMBODIMENTS

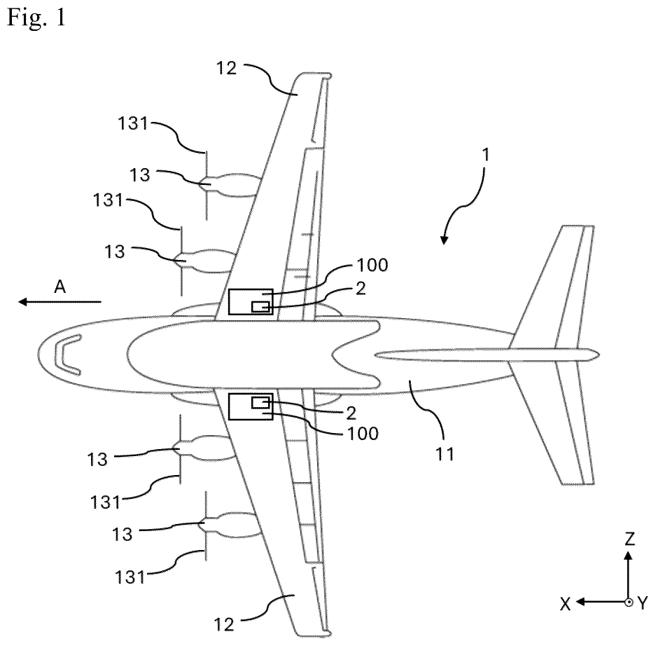

FIG. 1 shows an aircraft 1 which has a fuselage 11, on either side of which a wing 12 is secured. Secured under each wing 12 is at least one propulsion system 13.

By convention, the longitudinal direction of the aircraft 1 is denoted X, the transverse direction of the aircraft 1, which is horizontal when the aircraft 1 is on the ground, is denoted Y, and the vertical direction, or vertical height when the aircraft 1 is on the ground, is denoted Z, these three directions X, Y and Z being orthogonal to one another.

Furthermore, the terms “front” and “rear” should be considered with respect to a direction of forward movement of the aircraft 1 when the propulsion systems 13 are operating, this direction being indicated schematically by the arrow A.

In the embodiment of the invention that is presented here, the propulsion system 13 may be in the form of an electric motor comprising a propeller 131 mounted on the driveshaft of the electric motor, which is supplied with electricity by a fuel cell. The fuel cell is, in this case, supplied with oxygen and dihydrogen in order to produce electricity.

The aircraft 1 also comprises at least one system 100 for producing electrical energy, which is intended to supply the propulsion systems 13 of the aircraft 1. In FIG. 1, the system 100 is disposed in the wings 12, but it will easily be understood that the system 2 could also be located in the nacelle of the motor, or in some other part of the airplane, such as the fuselage 11.

The system 100 for producing electrical energy comprises a fuel cell using dihydrogen as fuel. Conventionally, the system 100 for producing electrical energy therefore comprises a circuit for supplying and distributing dihydrogen (preferably in the form of a gas) to the fuel cell and a circuit for supplying and distributing air (preferably oxygen) to the fuel cell. The dihydrogen and the air allow the fuel cell to create electrical energy by virtue of the chemical redox reaction that takes place between the anode and the cathode of the fuel cell.

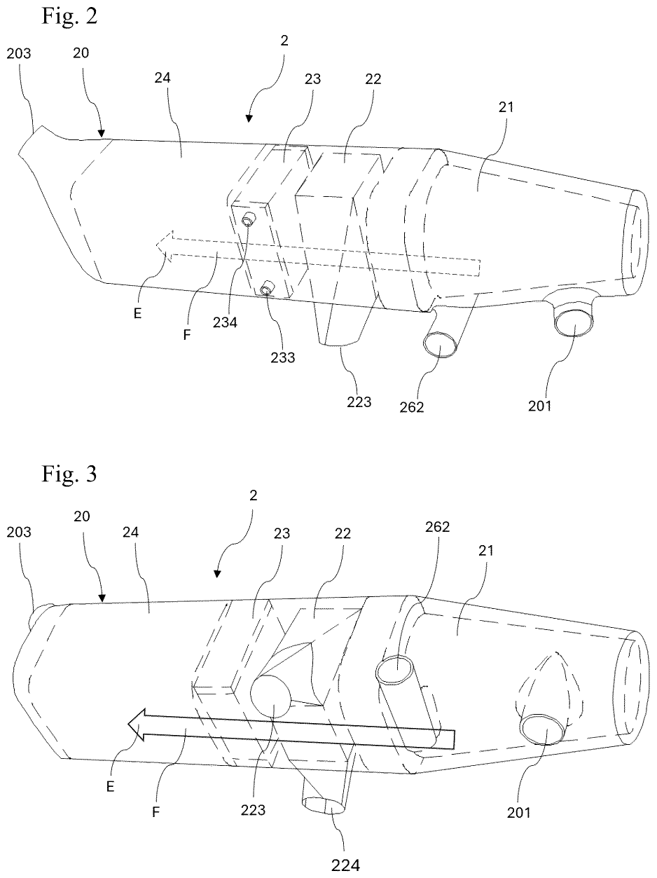

According to the invention, and as illustrated in FIGS. 2 to 6b, the circuit for supplying and distributing air comprises an air supply module 2 which comprises a housing 20 having an inlet orifice 201 and an outlet orifice 203. An air flow (indicated by the arrow F in the figures) flows between the inlet orifice 201 and the outlet orifice 203 along a flow direction E which extends generally along the longitudinal axis of the housing 20.

Preferably, the inlet orifice 201 is in fluidic communication with a source of ambient air. Also preferably, the ambient air arriving at the inlet orifice 201 of the module 2 is pressurized by a compressor (not illustrated) which takes the ambient air at the nacelle of the propulsion system. Optionally, a filter (not shown) can be employed upstream of the compressor in order to filter the largest particles.

For its part, the outlet orifice 203 is in fluidic communication with the fuel cell in order to supply the latter with oxygen so as to bring about the redox reaction and thus to create electrical energy.

The module 2 also comprises, accommodated in the housing 20, between the inlet orifice 201 and the outlet orifice 203:
a first filter 21 having a first inlet 211 through which the air flow F enters the first filter 21, and a first outlet 212 through which the air flow F exits the first filter 21; and
a first heat exchanger 22 having a second inlet 221 through which the air flow F enters the first heat exchanger 22, and a second outlet 222 through which the air flow F exits the first heat exchanger 22. The first heat exchanger 22 is disposed downstream of the first filter 21 with respect to the direction of flow E, that is to say, in this case, between the first filter 21 and the outlet orifice 203.

The first outlet 212 of the first filter 21 and the second inlet 221 of the first heat exchanger 22 are in direct fluidic communication with one another.

When the housing 20 does not have an element for treating the air flow F other than the first filter 21 and the first heat exchanger 22, the second outlet 222 of the first heat exchanger 22 and the outlet orifice 203 are in direct fluidic communication with one another. When other elements for treating the air flow F are employed in the module 2 (as described in the description below), the second outlet of the first heat exchanger 22 and the outlet orifice 203 are in indirect fluidic communication with one another. In this case, it is the outlet of the element for treating the air flow F situated farthest downstream (that is to say, the treatment element situated last upstream of the outlet orifice 203 with respect to the direction of flow of the air flow F) which is in direct fluidic communication with the outlet orifice 203 of the housing 20.

In this description, where it is stated that an outlet and an inlet (or more generally two elements) are in direct fluidic communication with one another, this means that the outlet and the inlet are connected directly together, that is to say, without a connecting hose being connected in between.

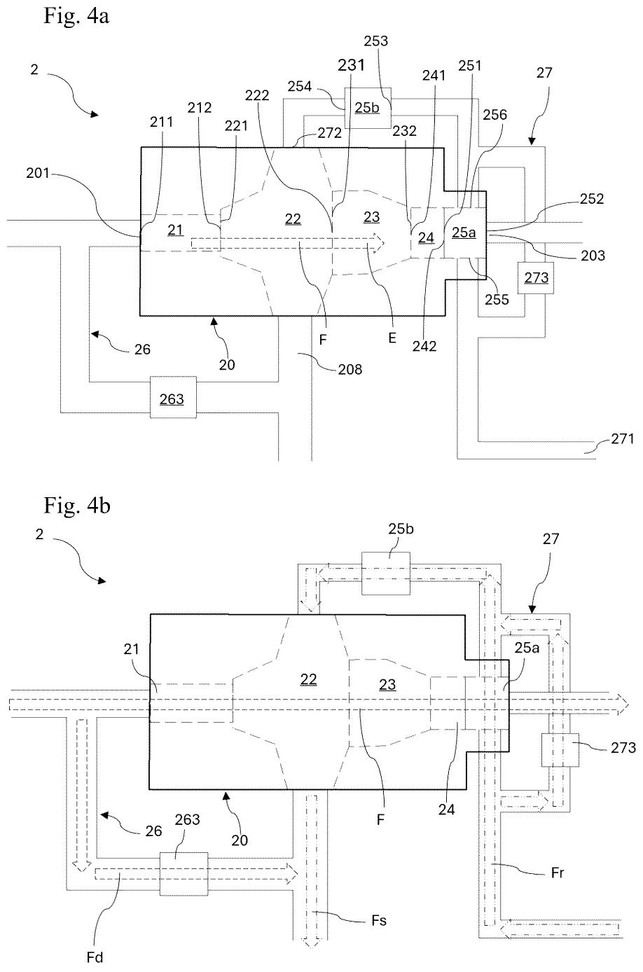

More specifically, according to the first embodiment illustrated in FIGS. 4a and 4b, the first filter 21 is thus next to the first exchanger 22 and the first outlet 212 of the first filter 21 therefore leads directly into the second inlet 221 of the first heat exchanger 22 without an intermediate connecting element. In one variant, a connector, for example of the male/female type, is integrated between the first outlet 212 and the second inlet 221.

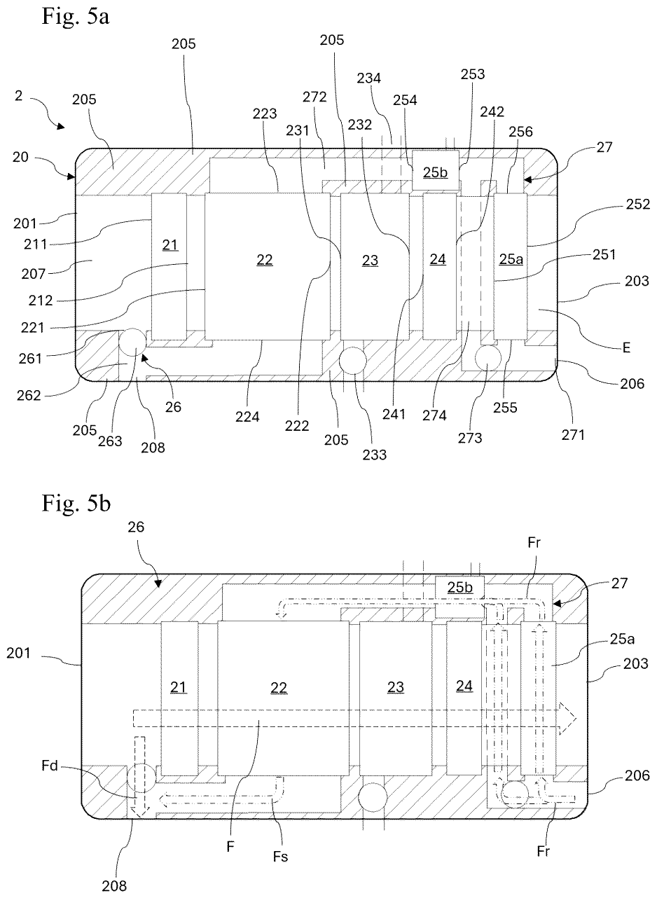

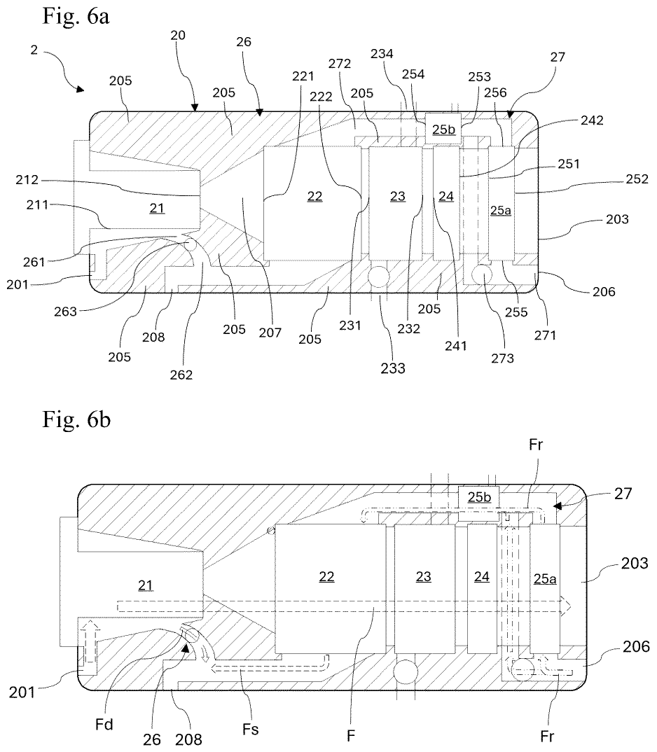

According to a second embodiment, illustrated in FIGS. 5a to 6b, the first filter 21 and the first heat exchanger 22 are in direct fluidic communication with one another by means of internal walls 205 of the housing 20 (as described in more detail below). Thus, it is also possible to dispense with the employment of connecting hoses for connecting the first filter 21 and the first heat exchanger 22.

In any case, the module 2 according to the invention makes it possible to do away with the use of connecting hoses between the first filter 21 and the first heat exchanger 22.

In this way, and on account of the lack of a connecting hose between the elements 21 and 22 for treating the air flow F, the module 2 according to the invention makes it possible to reduce the volume (and therefore the space requirement) of the circuit for supplying and distributing air of the fuel cell. It is therefore easier to integrate the module 2 into a system 100 for producing electrical energy.

In addition, it is possible for all the elements for treating the air flow employed within the module 2 to be assembled before the latter is installed in the system 100 for producing electrical energy. Therefore, and on account of the small space requirement of the module 2, it is also easier to assemble the latter with the system 100 for producing electrical energy, all the more so when the system 100 for producing electrical energy is employed in an aircraft, since the working space for operators is generally limited within the wing 12 or the fuselage 11 of the aircraft 1.

Lastly, such a module 2 also allows a significant weight saving, this being relatively advantageous when the module 2 is intended to be installed onboard an aircraft 1.

When the first heat exchanger 22 is of the air/air type, the first heat exchanger 22 therefore cools or heats the air flow F with thermal air (which can therefore be colder/hotter than the air flow F passing longitudinally through the first heat exchanger 22). This thermal air generally passes transversely through the first heat exchanger 22, that is to say, along a direction generally perpendicular to the direction E of the air flow F. To this end, the first heat exchanger 22 has a first additional inlet 223 through which the thermal air enters the first heat exchanger 22, and a first additional outlet 224 through which the thermal air exits the first heat exchanger 22. As described in more detail below, the thermal air entering the first heat exchanger 22 may come from a recirculation flow Fr.

The first additional outlet 224 through which the thermal air exits the first heat exchanger 22 thus forms an evacuation outlet for the thermal air after heat exchange with the air flow F has taken place within the first heat exchanger 22. The first additional outlet 224 of the first heat exchanger 22 is in direct fluidic communication with an additional outlet orifice 208 of the housing 20, which makes it possible to evacuate the air from the housing 20. Preferably, the air flow Fs output by the first additional outlet 224 of the first heat exchanger 22 is evacuated via the additional outlet orifice 208 and can be transported to a turbine of the propulsion system 13 of the aircraft 1, for example. In this way, the consumption and use of the air within the module 2 are optimized.

Preferably, and as illustrated in FIGS. 2 to 6b, the module 2 also comprises, accommodated in the housing 20 between the inlet orifice 201 and the outlet orifice 203:
a second heat exchanger 23 having a third inlet 231 through which the air flow F enters the second heat exchanger 23, and a third outlet 232 through which the air flow F exits the second heat exchanger 23, the second heat exchanger 23 being disposed downstream of the first heat exchanger 22 with respect to the direction of flow E; and
a second filter 24 having a fourth inlet 241 through which the air flow F enters the second filter 24, and a fourth outlet 242 through which the air flow F exits the second filter 24, the second filter 24 being disposed downstream of the second heat exchanger 23 with respect to the direction of flow E.

More specifically, the second outlet 222 of the first heat exchanger 22 and the third inlet 231 of the second heat exchanger 23 are in direct fluidic communication with one another. In the same way, the third outlet 232 of the second heat exchanger 23 and the fourth inlet 241 of the second filter 24 are in direct fluidic communication with one another.

Thus, the elements 21 to 24 for treating the air flow F are disposed in series, one after another, without a connecting hose in between for connecting them, so as to further promote the reduction in the space requirement of the circuit for supplying and distributing air.

The direct fluidic communication between the treatment elements 21 to 24 can be brought about by a direct connection according to the first embodiment described in conjunction with FIGS. 4a and 4b or by means of the internal walls 205 of the housing 20 according to the second embodiment described in conjunction with FIGS. 5a to 6b.

Preferably, and as illustrated in FIGS. 4a to 6b, the module 2 also comprises, accommodated in the housing 20 between the inlet orifice 201 and the outlet orifice 203, a humidifier 25a which has a fifth inlet 251 through which the air flow F enters the humidifier 25a and a fifth outlet 252 through which the air flow F exits the humidifier 25a. The humidifier 25a is disposed downstream of the second filter 24 with respect to the direction of flow E, that is to say, between the second filter 24 and the outlet orifice 203.

The fifth inlet 251 of the humidifier 25a and the fourth outlet 242 of the second filter 24 are in direct fluidic communication with one another. In the same way, the fifth outlet 252 of the humidifier 25a and the outlet orifice 203 of the module 2 are in direct fluidic communication with one another. The humidifier 25 makes it possible to add humidity which is suitable for the air flow F before the air flow F enters the fuel cell.

Thus, the set of elements 21 to 25a for treating the air flow F are disposed in series, one after another, without a connecting hose in between for connecting them, so as to further promote the reduction in the space requirement of the circuit for supplying and distributing air. The direct fluidic communication between the treatment elements 21 to 25a can be brought about by a direct connection according to the first embodiment in FIGS. 4a and 4b or by means of the internal walls 205 of the housing 20 according to the second embodiment in FIGS. 5a to 6b.

Preferably, and as illustrated in FIGS. 4a to 6b, the elements for treating the air flow F, which are the first filter 21, the first heat exchanger 22, the second heat exchanger 23, the second filter 24, and the humidifier 25a, are in this case disposed one after another, generally in parallel along a longitudinal axis of the module 2 that extends generally parallel to the air flow F. Thus, the air flow F can pass successively through the treatment elements 21 to 25a without its direction being substantially modified transversely. This makes it possible to reduce the space requirement of the module 2 and also to reduce the drag of the air flow F in the module 2 as a whole, thereby optimizing its operation.

FIGS. 5a to 6b illustrate the second embodiment. As described above, the housing 20 of the module 2 has internal walls 205 that form a flow channel 207 for the air flow F between the inlet orifice 201 and the outlet orifice 203. More specifically, the internal walls 205 fluidically connect at least some of the elements 21 to 25a for treating the air flow F. In this example, the set of treatment elements 21 to 25a are fluidically connected by internal walls 205. In other words, the set of elements are in direct fluidic communication with one another by virtue of the internal walls 205 of the housing 20. Similarly, the inlet orifice 201 and the outlet orifice 203 are in this embodiment connected fluidically to the first filter 21 and to the humidifier 25a, respectively.

The internal walls 205 may therefore make it possible, as desired, to place the first outlet 212 of the first filter 21 in direct fluidic communication with the second inlet 221 of the first heat exchanger 22, and/or the second outlet 222 of the first heat exchanger 22 in direct fluidic communication with the third inlet 231 of the second heat exchanger 23, and/or the third outlet 232 of the second heat exchanger 23 in direct fluidic communication with the fourth inlet 241 of the second filter 24, and/or the fourth outlet 242 of the second filter 24 in direct fluidic communication with the fifth inlet 251 of the humidifier 25a.

In this way, the elements 21 to 25a for treating the air flow F can be placed in fluidic communication without it being necessary to employ connecting hoses which would make the module 2 heavier and would increase the space requirement of the latter.

In the examples illustrated in FIGS. 4a to 6b, the set of treatment elements 21 to 25a are disposed in the housing 20 and are in direct fluidic communication with one another. In one variant, it would be conceivable for some treatment elements to be disposed outside the housing 20. For example, the humidifier 25a could be disposed at the outlet of the housing 20, and preferably in direct fluidic communication with the outlet orifice 203.

Preferably, the module 2 comprises a bypass circuit 26 which has a sixth inlet 261 through which the bypass flow Fd enters the bypass circuit 26, and a sixth outlet 262 through which the bypass flow Fd exits the bypass circuit 26. The bypass circuit 26 is preferably disposed between the inlet orifice 201 and an additional outlet orifice 208 of the housing 20. More specifically, the inlet orifice 201 of the housing 20 and the sixth inlet 261 of the bypass circuit 26 are in direct fluidic communication with one another, and the sixth outlet 262 of the bypass circuit is in direct fluidic communication with the additional outlet orifice 208 of the housing 20.

In this way, a part of the air flow entering the housing 20 can be directed directly toward the additional outlet orifice 208 of the housing 20 in order to adjust the flow rate and/or the quantity of air entering the elements 21 to 25a for treating the air flow F.

As illustrated in FIGS. 4a to 6b, the bypass circuit 26 also has a valve 263 disposed between the sixth inlet 261 and the sixth outlet 262. This valve makes it possible to selectively open and close the bypass circuit 26.

The bypass circuit 26 thus makes it possible to selectively cause a part of the air flow (then becoming the bypass flow Fd) to pass from the inlet orifice 201 of the housing 20 to the additional outlet orifice 208 of the housing 20 and, when it is connected thereto, to supply air to the turbine of the propulsion system 13 of the aircraft 1.

Preferably, the module 2 comprises a recirculation circuit 27 which has a seventh inlet 271 through which a recirculation flow Fr enters the recirculation circuit 27, and a seventh outlet 272 through which the recirculation flow Fr exits the recirculation circuit 27. The recirculation circuit 27 is disposed between an additional inlet orifice 206 of the housing 20 that is intended to be connected to a source of recirculation air and the first additional inlet 223 of the first heat exchanger 22. More specifically, the seventh inlet 271 of the recirculation circuit 27 and the additional inlet orifice 206 of the housing 20 are in direct fluidic communication with one another. Similarly, the seventh outlet 272 of the recirculation circuit 27 and the first additional inlet 223 of the first heat exchanger 22 are in direct fluidic communication with one another.

The additional air inlet orifice 206 is in fluidic communication with a source of recirculation air which, in this example, is air coming from the fuel cell. This recirculation air is obtained in this case following the redox reaction of the fuel cell.

Thus, the recirculation circuit 27 makes it possible to cause thermal air to enter at the first additional inlet 223 of the first heat exchanger 22. In particular in this case, the thermal air which allows heat exchanges with the air flow F within the first heat exchanger 22 comes from the fuel cell. In this way, the consumption and use of the air within the module 2 and the fuel cell are optimized.

The recirculation circuit 27 therefore makes it possible to supply thermal air to the first heat exchanger 22.

However, it may be conceivable for the thermal air used by the first heat exchanger 22 to come from a different air supply source which would be in fluidic communication with the additional inlet orifice 206.

Preferably, the recirculation circuit 27 also comprises a water separator 25b having an eighth inlet 253 and an eighth outlet 254 for the recirculation flow Fr, the water separator 25b being disposed between the first heat exchanger 22 and the humidifier 25a.

Thus, the recirculation circuit 27 may comprise a water separator 25b which makes it possible to remove water from the recirculation flow Fr coming, in this case, from the fuel cell before this recirculation flow is used as thermal air in the first heat exchanger 22. Thus, the water separator 25b makes it possible to collect moisture from the recirculation flow Fr in order to protect the heat exchanger 22 through which the recirculation flow Fr passes and the turbine of the propulsion system 13 of the aircraft 1 from moisture, when the additional outlet orifice 208 is connected thereto.

More specifically, the additional inlet orifice 206 of the housing 20 and a second additional inlet 255 of the humidifier 25a are in direct fluidic communication with one another, and a second additional outlet 256 of the humidifier 25a and the eighth inlet 253 of the water separator 25b are in direct fluidic communication with one another. In this way, the recirculation flow Fr flows from the additional inlet orifice 206 to the water separator 25b, passing through the humidifier 25a. Thus, the moisture in the recirculation flow Fr coming from the fuel cell is used, in part, to add water to the humidifier 25a in order to humidify the air flow F intended to exit the module 2 in order to subsequently enter the fuel cell.

Moreover, the eighth outlet 254 of the water separator 25b and the first additional inlet 223 of the first heat exchanger 22 are in direct fluidic communication with one another in order to supply the latter with thermal air.

Preferably, the recirculation circuit 27 also comprises a bypass channel 274 disposed between the additional inlet orifice 206 of the housing 20 and the eighth inlet 253 of the water separator 25a, the eighth inlet 253 of the water separator 25b and the additional inlet orifice 206 being in direct fluidic communication with one another via the bypass channel 274. In this way, the recirculation flow Fr can flow directly from the additional inlet orifice 206 to the water separator 25b, bypassing the humidifier 25a. Thus, only the part of the recirculation flow Fr that is necessary for adding water to the humidifier 25a passes through the humidifier 25a. The other part of the recirculation flow Fr therefore passes directly through the bypass channel 274.

The recirculation circuit 27 may also comprise a bypass valve 273, disposed in the bypass channel 274, which makes it possible, consequently, to cause the air coming from the fuel cell to pass or not to pass through the humidifier 25a.

According to the first embodiment illustrated in FIGS. 4a and 4b, the bypass circuit 26 and/or the recirculation circuit 27 is/are mounted on the outside of the housing 20. In this example, the bypass circuit 26 and the recirculation circuit 27 are both mounted on the outside of the housing 20. This makes it possible to provide a housing 20 having a simple structure in which the treatment elements 21 to 25 are accommodated.

According to the second embodiment illustrated in FIGS. 5a to 6b, the bypass circuit 26 and/or the recirculation circuit 27 is/are formed by internal walls 205 of the housing 20. In this example, the bypass circuit 26 and the recirculation circuit 27 are both integrated into the housing 20. In other words, it is the internal walls 205 of the housing 20 which define the bypass circuit 26 and recirculation circuit 27. Such an implementation thus makes it possible to limit the space requirement and the weight of the air supply module 2.

Preferably, the first filter 21 and/or the second filter 24 is/are in the form of a cartridge that is removable from the housing 20. This makes it easier to maintain the filters, which are considered to be so-called “consumable” elements. Specifically, unlike the prior art, in which it is necessary to remove each filter which is connected by means of connecting hoses to the other elements for treating the air flow F, the invention provides for the filters to be removed and installed quickly and easily, thereby making maintenance operations easier. Such an implementation is allowed by virtue of the housing 20 which integrates the filters 21 and 24.

According to the illustrated examples, the first filter 21 combines a first mechanical filter stage and, optionally, downstream of the first filter stage, a second ozone filter stage (also referred to as an ozone converter). Disposing the second filter stage downstream of the first filter stage makes it possible to protect the filtration of ozone from particles which are retained by the mechanical filtration. The second filter stage could be omitted if the fuel cell accepted air containing ozone.

In addition, the first heat exchanger 22 is of the air/air type, the second heat exchanger 23 is of the liquid/air type, and the second filter 24 is an adsorbent chemical filter.

Such a combination of filters and of heat exchangers allows optimal treatment of the air which supplies the fuel cell, thereby optimizing the performance of the fuel cell.

As illustrated in FIGS. 5a to 6b, when the second heat exchanger 23 is of the air/liquid type, it has a cooling liquid inlet 233 through which the cooling liquid enters the second heat exchanger 23, and a cooling liquid outlet 234 through which the cooling liquid exits the second heat exchanger 23. The cooling liquid inlet 233 and the cooling liquid outlet 234 may lead out of the housing 20 so as to allow the second heat exchanger 23 to be supplied with cooling liquid and to allow the cooling liquid to be evacuated from the second heat exchanger 23.

Although not illustrated, it will clearly be understood that valves and/or sensors may be employed within the housing 20 in order to optimize the management of the air flow through the module 2.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An air supply module for a system for producing electrical energy comprising a fuel cell, said air supply module comprising:
a housing which has an inlet orifice and an outlet orifice and through which an air flow flows along a direction of flow between said inlet orifice and said outlet orifice, and
accommodated in the housing, between said inlet orifice and said outlet orifice, a first filter having a first inlet and a first outlet for said air flow and a first heat exchanger having a second inlet and a second outlet for said air flow, said first heat exchanger being disposed downstream of the first filter with respect to the direction of flow,
wherein said first outlet of said first filter and said second inlet of said first heat exchanger are in direct fluidic communication with one another,
wherein said air supply module also comprises, accommodated in the housing, between said inlet orifice and said outlet orifice, a second heat exchanger having a third inlet and a third outlet for said air flow, said second heat exchanger being disposed downstream of the first heat exchanger, and a second filter having a fourth inlet and a fourth outlet for said air flow, said second filter being disposed downstream of the second heat exchanger, and
wherein said second outlet of said first heat exchanger and said third inlet of said second heat exchanger are in direct fluidic communication with one another, and wherein said third outlet of said second heat exchanger and said fourth inlet of said second filter are in direct fluidic communication with one another.

2. The air supply module as claimed in claim 1, wherein said air supply module also comprises, accommodated in the housing, between said inlet orifice and said outlet orifice, a humidifier having a fifth inlet and a fifth outlet for said air flow, said humidifier being disposed downstream of the second filter,
wherein said fifth inlet of said humidifier and said fourth outlet of said second filter are in direct fluidic communication with one another, and
wherein said fifth outlet of said humidifier and said outlet orifice of said module are in direct fluidic communication with one another.

3. The air supply module as claimed in claim 2,
wherein said housing has internal walls that form a flow channel for said air flow between said inlet orifice and said outlet orifice, and
wherein said internal walls place at least one of:
the first outlet of the first filter in direct fluidic communication with the second inlet of the first heat exchanger,
the second outlet of the first heat exchanger in direct fluidic communication with the third inlet of the second heat exchanger,
the third outlet of the second heat exchanger in direct fluidic communication with the fourth inlet of the second filter, or
the fourth outlet of the second filter in direct fluidic communication with the fifth inlet of the humidifier.

4. The air supply module as claimed in claim 1, which comprises a bypass circuit having a sixth inlet and a sixth outlet for a bypass flow, said bypass circuit being disposed between said inlet orifice and an additional outlet orifice of said housing,
wherein said inlet orifice and said sixth inlet are in direct fluidic communication with one another, and
wherein said sixth outlet and said additional outlet orifice of the housing are in direct fluidic communication with one another.

5. The air supply module as claimed in claim 2, which comprises a recirculation circuit having a seventh inlet and a seventh outlet for a recirculation flow, said recirculation circuit being disposed between an additional air inlet orifice of said housing that is configured to be connected to a source of recirculation air and a first additional inlet of said first heat exchanger,
wherein said seventh inlet and said additional inlet orifice are in direct fluidic communication with one another, and wherein said seventh outlet and said first additional inlet of said first heat exchanger are in direct fluidic communication with one another.

6. The air supply module as claimed in claim 5,
wherein said recirculation circuit further comprises a water separator having an eighth inlet and an eighth outlet for said recirculation flow, said water separator being disposed between said first heat exchanger and said humidifier;
wherein said additional inlet orifice and a second additional inlet of the humidifier are in direct fluidic communication with one another, and wherein a second additional outlet of said humidifier and said eighth inlet of said water separator are in direct fluidic communication with one another such that said recirculation flow flows from said additional inlet orifice to said water separator, passing through said humidifier; and
wherein said eighth outlet of said water separator and said first additional inlet of said first heat exchanger are in direct fluidic communication with one another.

7. The air supply module as claimed in claim 6, wherein said recirculation circuit further comprises a bypass channel disposed between said additional inlet orifice of said housing and said eighth inlet of said water separator, said eighth inlet of said water separator and said additional inlet orifice being in direct fluidic communication with one another via said bypass channel such that said recirculation flow flows from said additional inlet orifice to said water separator, bypassing said humidifier.

8. The air supply module as claimed in claim 5, wherein said bypass circuit, said recirculation circuit or both said bypass circuit and said recirculation circuit is or are mounted on the outside of said air supply module.

9. The air supply module as claimed in claim 5, wherein said bypass circuit, said recirculation circuit or both said bypass circuit and said recirculation circuit is or are formed by internal walls of said module.

10. The air supply module as claimed in claim 1, wherein said first filter, said second filter or both said first filter and said second filter is or are formed as a cartridge that is removable from said housing.

11. The air supply module as claimed in claim 1,
wherein said first filter has a first mechanical filter stage, or a first mechanical filter stage and a second ozone filter stage, disposed downstream of said first filter stage,
wherein said first heat exchanger is of an air/air type,
wherein said second heat exchanger is of a liquid/air type, and
wherein said second filter is an adsorbent chemical filter.

12. A system for producing electrical energy, comprising at least one fuel cell and at least one air supply module as claimed in claim 1, wherein said at least one fuel cell is supplied with air from the outlet orifice of said at least one air supply module.

13. An electrical propulsion system of an aircraft, which is supplied with electricity by the at least one system for producing electrical energy as claimed in claim 12.

14. An aircraft comprising the at least one electrical propulsion system as claimed in claim 13.
